(19) United States
(12) Patent Application Publication
(10) Pub. No.: US 2024/0346483 A1
(43) Pub. Date: Oct. 17, 2024

(54) Locking Non-Fungible Token Transfers for Collection Building

(71) Applicant: Dapper Labs, Inc., Vancouver (CA)

(72) Inventors: Nick TREMMAGLIA, Rockland (CA); Taylor PETRYCHYN, Vancouver (CA); Bob WEI, Richmond (CA); Alan CARR, Las Vegas, NV (US); Justin OSTROWSKI, Atlanta, GA (US); Alexandr NI, Toronto (CA); Frank LEE, Queens, NY (US); Matthew SPECTOR, Los Angeles, CA (US)

(21) Appl. No.: 18/299,733

(22) Filed: Apr. 13, 2023

(51) Int. Cl. G06Q 20/36; G06Q 20/38

(52) U.S. Cl. CPC G06Q 20/363; G06Q 20/389

(57) ABSTRACT

Aspects of the present disclosure are directed to locking non-fungible tokens (NFTs), linked to digital collectibles, from being transferred. Digital collectibles can be any suitable unit of data affiliated with person(s), organization(s), or any other entities. A digital collectible can comprise a display component that supports display of the digital collectible data. Digital collectible data can include an affiliated person (e.g., a sports player), an affiliated team (e.g., a sports team), a digital media file (e.g., video clip, image, etc.), or any other suitable digital collectible data. Ownership of a digital collectible is transferred via ownership of the NFT linked to the digital collectible. Implementations support a lock command from user(s) that lock a given NFT, and its corresponding linked digital collectible, to the user for a period of time (e.g., 6 months, a year, etc.).

### TECHNICAL FIELD

The present disclosure is directed to locking non-fungible token (NFT) transfer(s), using smart contracts, to support NFT collection(s).

### BACKGROUND

A blockchain is a list of records, each called a block, which can be linked through cryptography. Each block includes a timestamp, a hash of the previous block, and transaction data. The timestamp proves that the transaction data was included when the block was added in order to get its hash. Because each block specifies the block previous to it, the set of blocks make a chain, with each new block reinforcing the set of blocks before it in the chain. Therefore, blockchains are very difficult to modify because data, once added to the blockchain, cannot be altered without altering all subsequent blocks.

Non-Fungible Tokens (NFTs), are blockchain-backed identifiers specifying a unique (digital or real-world) item. Through a distributed ledger, the ownership of these tokens can be tracked and verified. Such tokens can link to a representation of the unique item, e.g., via a traditional URL or a distributed file system such as IPFS. While a variety of blockchain systems support NFTs, common platforms that supports NFT exchange allow for the creation of unique and indivisible NFT tokens.

Traditionally, NFTs represent a way of being able to define ownership for practically anything that is digital. In other words, any material that can be digitized or which is already in a digital format can be the subject of an NFT. Some examples of NFT content can include digital photographs, video frames, social media interactions, and virtually all items that can be converted for receipt and processing by a computer (e.g., a scanned autograph). Asset ownership via digital items, such as NFTs, has grown in popularity. NFTs can include identifying information that identifies the asset tied to the NFT, such as unique identifying information, a web link, or other suitable identifying information. NFTs can be managed on a blockchain, thus providing transparency and reliability to the asset ownership.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a conceptual diagram illustrating components for locking non-fungible token (NFT) transfer(s) to support NFT collection(s).

FIG. 5 is a conceptual diagram of a digital collectible affiliated with an NFT.

FIG. 6 is a conceptual diagram of leaderboards that correspond to ranked collection metrics.

FIG. 7 is a flow diagram illustrating a process used in some implementations for locking NFT transfer(s) to support NFT collection(s).

FIG. 8 is a flow diagram illustrating a process used in some implementations for locking an NFT to a user via a locking smart contract.

FIG. 9 is a flow diagram illustrating a process used in some implementations for generating collection metric(s), ranking the metric(s), and displaying the ranking metric(s).

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to locking non-fungible token (NFT) transfer(s) to support NFT collection(s). NFTs are blockchain-backed identifiers specifying an item, such as a digital item. In some implementations, NFTs are linked to digital collectibles. Digital collectibles can be any suitable unit of data (e.g., data structure) affiliated with person(s), organization(s), or any other suitable entities. A digital collectible can comprise a display component that supports display of the digital collectible data. For example, digital collectible data can include an affiliated person (e.g., a sports player), an affiliated team (e.g., a sports team), a digital media file (e.g., video clip, image, etc.), or any other suitable digital collectible data. Ownership of a digital collectible is transferred via ownership of the NFT linked to the digital collectible. Thus, digital collectibles can be traded among users in a NFT marketplace. Implementations support a lock command that locks a given NFT, preventing a corresponding digital collectible, linked to the NFT, from being transferred from a user for a period of time (e.g., 6 months, a year, etc.). Locked digital collectibles can participate in events or other suitable application functionality that unlocked digital collectibles cannot. In some implementations, locked digital collectibles can contribute value to certain collection metric(s) for a user, and these collection metric(s) can be ranked among community users' collection metric(s) and displayed via leaderboards.

In some implementations, the NFTs linked to the digital collectibles can be managed at one or more blockchain(s). For example, the blockchain(s) can store transactions such that ownership of the NFTs is maintained in a trusted manner. A marketplace transfer can comprise one or more smart contracts transferring an NFT with an NFT identifier from a seller token wallet to a buyer token wallet, and appending this transaction to the blockchain(s) that manage the NFT(s). Ownership of the digital collectible linked to the NFT is transferred from the seller affiliated with the seller token wallet to the buyer affiliated with the buyer token wallet.

The locking of an NFT to a user (e.g., user token wallet identifier) can include smart contract call(s) and/or lock wallet functionality. Smart contract(s) and/or a lock wallet can perform one or more of the following to lock an NFT and linked digital collectible to a user: add the NFT identifier to a separate data structure (e.g., separate blockchain) that maintains locked NFTs; alter the token data of the NFT to indicate the locked status; move the NFT to a portion of the user's token wallet that stores locked NFTs; and/or any other suitable locking action. The smart contract(s) that execute transactions for the NFTs can comprise a condition that checks the lock status of a NFT before executing a transaction. When the check indicates the NFT is locked, the smart contract(s) do not execute the transaction.

In some implementations, a score engine can generate collection metric(s) with respect to a user based on the NFTs locked to the user. For example, the digital collectibles associated with NFTs can comprise features, such as affiliated players, affiliated teams, digital media file(s), etc. A collection of digital collectibles can include a set of collectibles that comprise: the same player identifier; or the same team identifier. The collection metric for a given user with respect to a specific player identifier can be the aggregate of the assigned values for NFTs/digital collectibles that are affiliated with the specific player identifier and locked to the user. The collection metric for a given user with respect to a specific team identifier can be the aggregate of the assigned values for NFTs/digital collectibles that are affiliated with the specific team identifier and locked to the user.

In some implementations, a user's player specific and/or team specific collection metric(s) can be ranked among the collection metric(s) for a community of users. For a specific player, the user's collection metric can be ranked against the player specific collection metrics for a community of users, and this ranking can be displayed at a player specific leaderboard. For a specific team, the user's collection metric can be ranked against the team specific collection metrics for a community of users, and this ranking can be displayed at a team specific leaderboard.

Implementations improve NFT management systems by stabilizing NFT marketplaces and improving the resource efficiency of these systems. For example, the traditional way that users interact with NFTs and linked digital collectibles is via marketplace transactions. However, voluminous marketplace transactions can create high load on NFT management systems due to the resource requirements for appending transactions to a blockchain. Implementations create an alternative approach to user interactions with NFTs and linked digital collectibles. The locked NFTs and leaderboard(s) achieved by implementations permit users to derive value and satisfaction from a user's digital collectible while pausing ownership transfers of the digital collectible over the lock timer. The pause in ownership transfers reduces the processing load on NFT systems while providing an alternative way for users to interact with their digital collectibles and socialize with the community of users.

In another example, NFT marketplaces can be highly volatile based on the scarcity of the digital items to which the NFTs are linked. Implementations reduce the quantity of NFTs available for transfers, thus improving scarcity and stabilizing the NFT marketplace. Unstable NFT marketplaces can present an existential risk to an NFT management system, and thus techniques that improve stability improve the overall system performance.

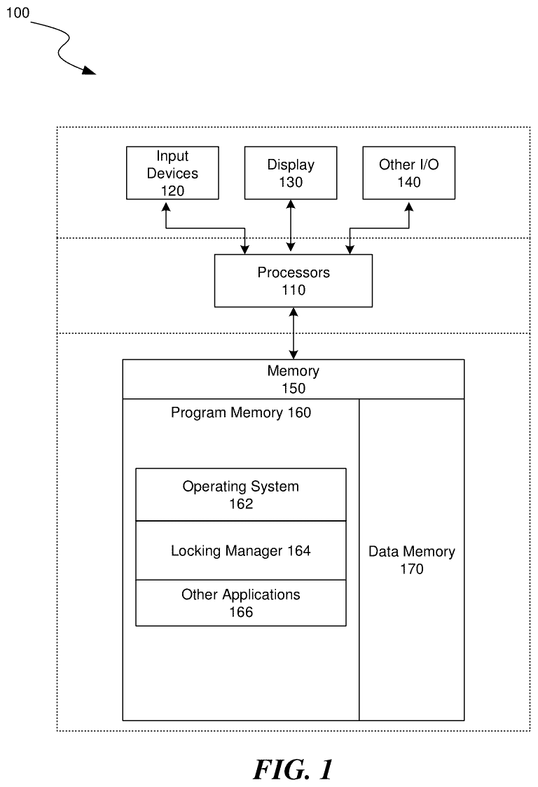

Several implementations are discussed below in more detail in reference to the figures. FIG. 1 is a block diagram illustrating an overview of devices on which some implementations of the disclosed technology can operate. The devices can comprise hardware components of a device 100 that lock non-fungible token (NFT) transfer(s) to support NFT collection(s). Device 100 can include one or more input devices 120 that provide input to the Processor(s) 110 (e.g., CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera- or image-based input device, a microphone, or other user input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, locking manager 164, and other application programs 166. Memory 150 can also include data memory 170, e.g., moment identifiers, leaderboard metrics, calculated moment values, configuration data, settings, user options or preferences, etc., which can be provided to the program memory 160 or any element of the device 100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

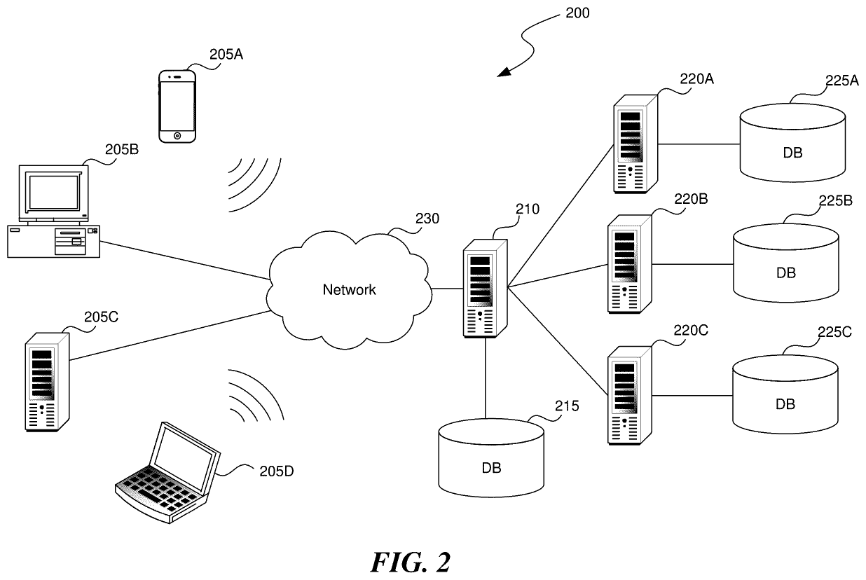

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g., store) information such as moment identifiers, leaderboard metrics, calculated moment values, moment and/or collection visual data (e.g., images, videos, etc.), and other suitable data. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

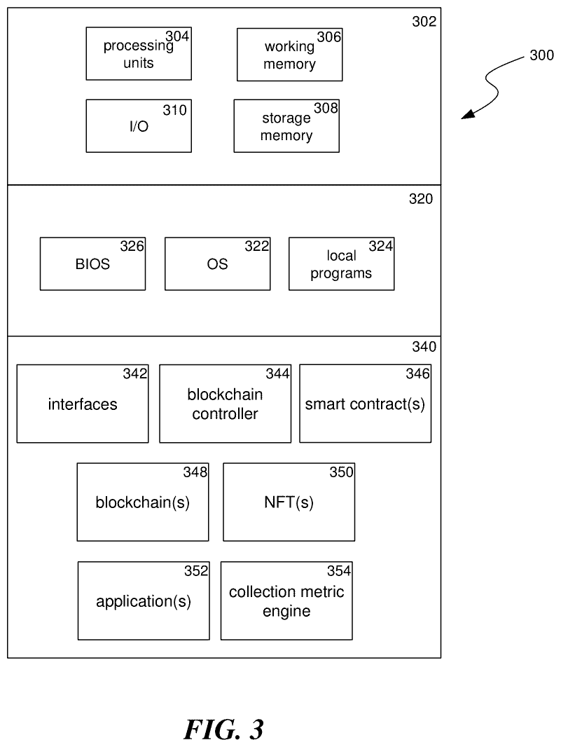

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including processing units 304 (e.g. CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 215 or storage provided through another server 220). Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include blockchain controller 344, smart contract(s) 346, blockchain(s) 348, NFT(s) 350, application(s) 352, and collection metric engine 354, and components which can be used for providing user interfaces, transferring data, and controlling the specialized components, such as interfaces 342. In some implementations, components 300 can be in a computing system that is distributed across multiple computing devices or can be an interface to a server-based application executing one or more of specialized components 340. Although depicted as separate components, specialized components 340 may be logical or other nonphysical differentiations of functions and/or may be submodules or code-blocks of one or more applications.

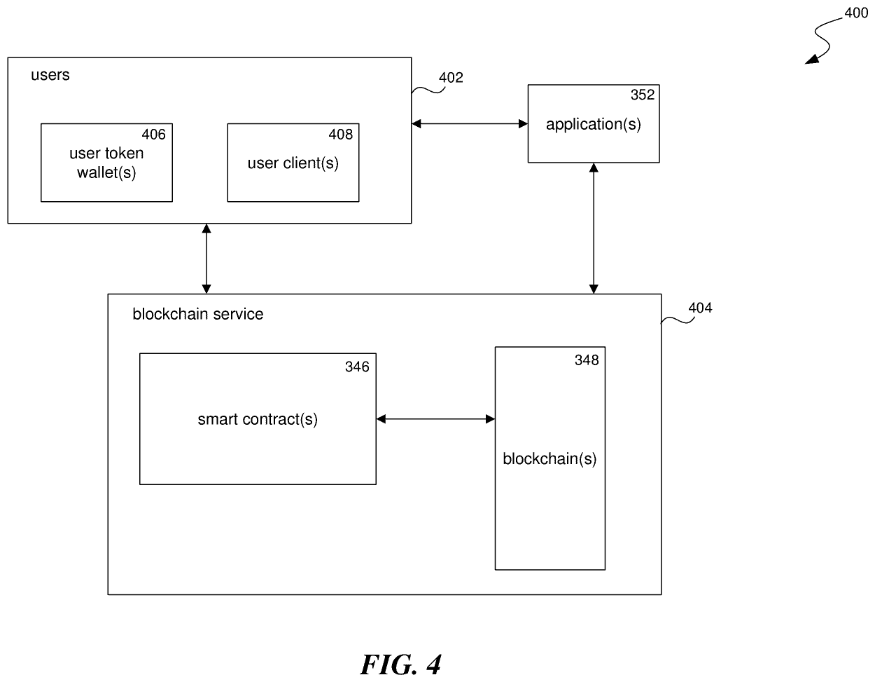

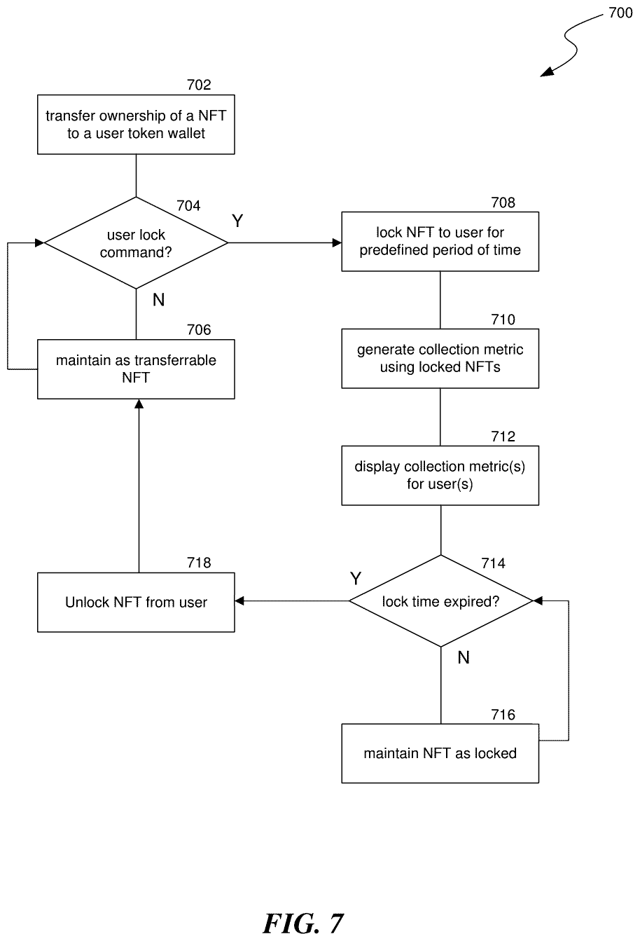

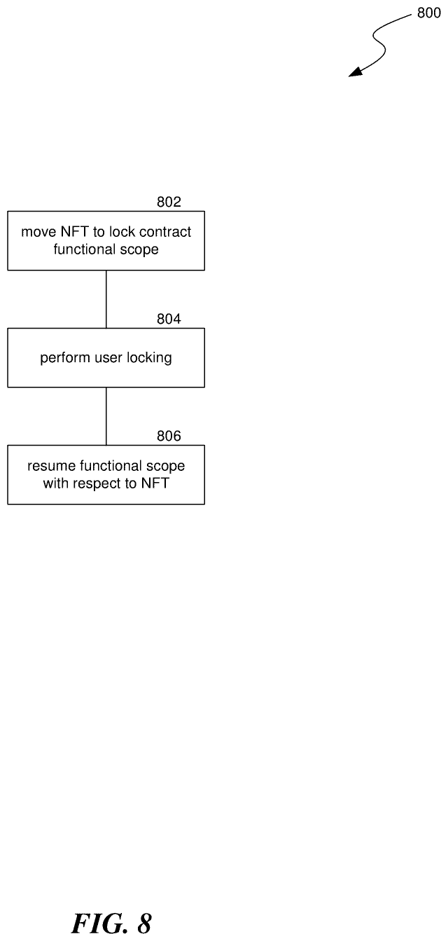

Blockchain controller 344 can be software module(s) that manage blockchain(s) 348 via commands, for example using smart contract(s) 346. Blockchain controller 344 can issue calls using smart contract(s) 346 to append NFT transactions to blockchain(s) 348. For example, blockchain controller 344 can, via smart contract(s) 346, append NFT transaction(s) to blockchain(s) 348 that transfers ownership of an NFT from a first token wallet (e.g., owner user token wallet, originating token wallet, etc.) to a second token wallet (e.g., new owner user token wallet). Additional details on blockchain controller 344 are provided below in relation to blockchain service 404 of FIG. 4, process 700 of FIG. 7, and process 800 of FIG. 8.

Smart contract(s) 346 can be software logic that executes when a series of conditions are met. For example, a smart contract can be an application programming interface (API) that automatically executes when the conditions of the smart contract are met. The execution of smart contract(s) 346 manipulates blockchain(s) 348, such as by appending one or more blocks to blockchain(s) 348. In some implementations, the combination of the cryptographic data structure implemented by blockchain(s) 348, and the trustworthy software logic executed via smart contract(s) 346 achieves the trusted immutable ledger of transactions for NFT(s) 350 recorded by blockchain(s) 348.

In some implementations, smart contract(s) 346 include one or more locking smart contracts that lock a particular NFT to a particular user/token wallet. For example, once the locking smart contract executes, the particular NFT is locked to the user/user token wallet for at least a predefined period of time (e.g., 1 day, 1 week, 1 month, 3 months, 6 months, 1 year, 18 months, etc.). Once locked, smart contract(s) 346 cannot perform a transaction that changes the ownership of the locked NFT until the locked time period expires. For example, one or more of smart contract(s) 346 that execute NFT transactions can include a condition that requires an NFT to be unlocked in order to perform a transfer of the NFT. Additional details on smart contract(s) 346 are provided below in relation to blockchain service 404 of FIG. 4, process 700 of FIG. 7, and process 800 of FIG. 8.

Blockchain(s) 348 can maintain a distributed ledger for NFT(s) 350 that records ownership of NFT(s) 350. In some implementations, NFT(s) 350 comprise one or more data fields, and blockchain(s) 346 store the data field values of NFT(s) 350 as part of the distributed ledger. Blockchain controller 344 can maintain blockchain(s) 348 so that the blockchain(s) record an immutable ledger of transactions for NFT(s) 350 that can reliably prove the token wallet (e.g., user) that owns particular ones of NFT(s) 350. Additional details on blockchain(s) 348 are provided below in relation to blockchain service 404 of FIG. 4, process 700 of FIG. 7, and process 800 of FIG. 8.

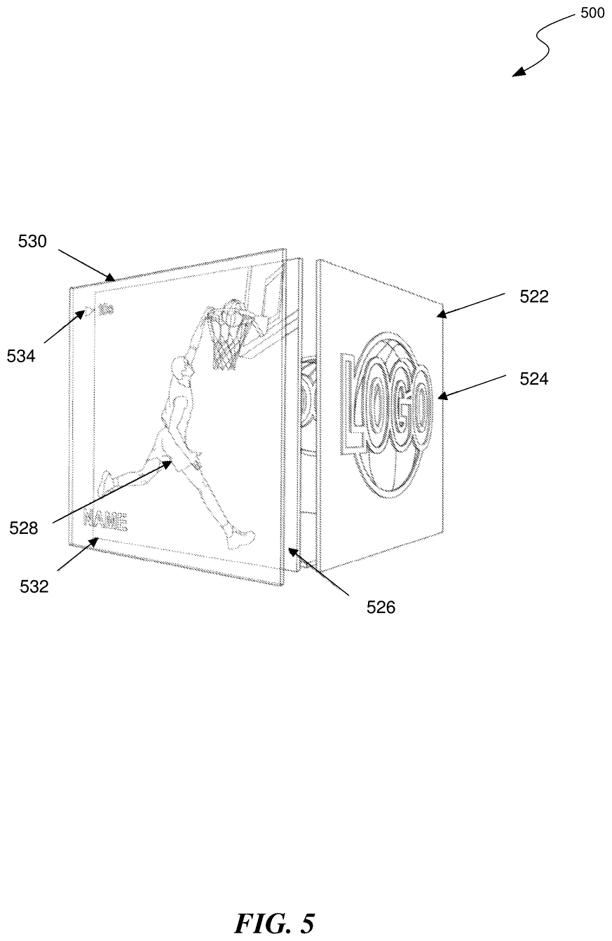

In some implementations, NFT(s) 350 comprise one or more collections of NFTs affiliated with one or more organizations or individuals. For example, a given one of NFT(s) 350 can be linked to a particular digital collectible that comprises one or more features. For example, the particular digital collectible can be affiliated with a player and/or a team. The particular digital collectible can also be affiliated with a moment for the player, such as a digital media file (e.g., an image, video, or any other suitable media file). In this example, the given one of NFT(s) 350 represents ownership of the particular digital collectible to which it is linked. In some implementations, multiple NFT(s) 350 can be affiliated with a given player, and each of the multiple NFT(s) can be affiliated with a different moment for the player. In some implementations, NFT(s) 350 comprise semi-fungible tokens. Additional details on NFT(s) 350 are provided below in relation to blockchain service 404 of FIG. 4, digital collectible 500 of FIG. 5, process 700 of FIG. 7, and process 800 of FIG. 8.

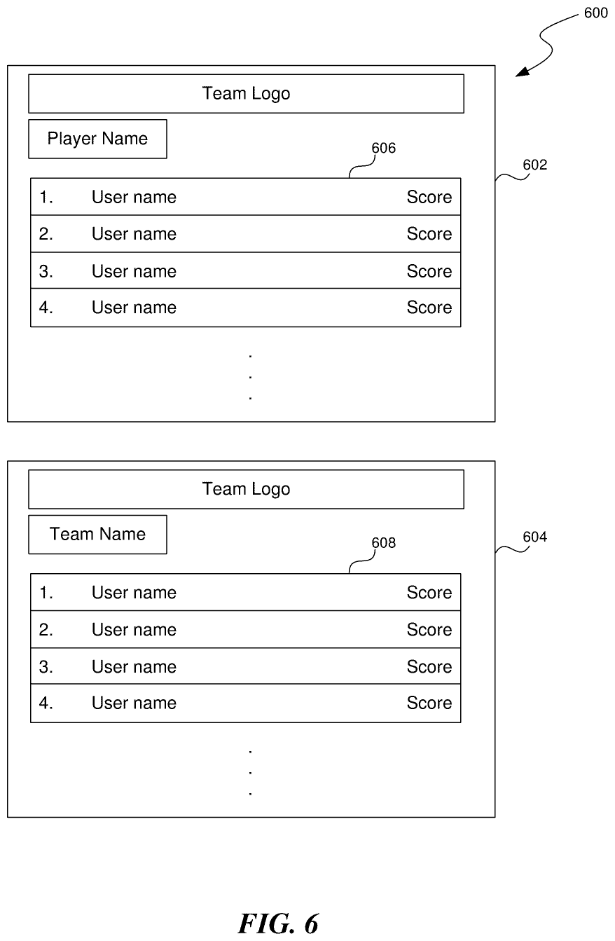

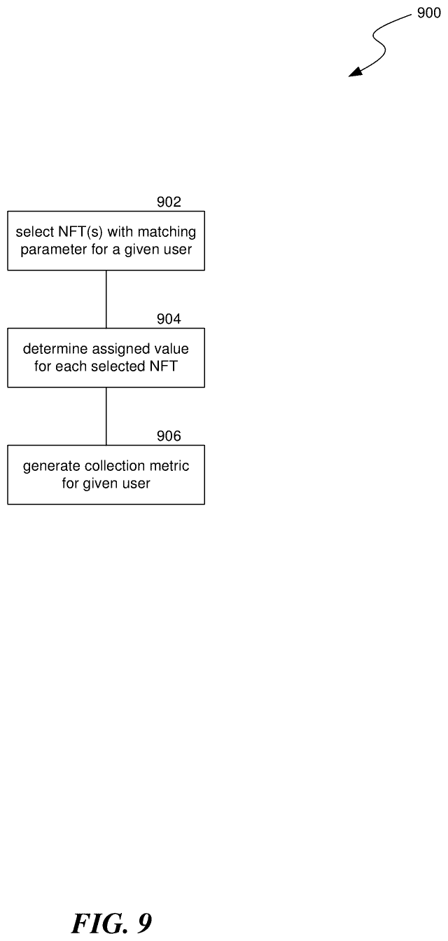

Application(s) 352 can be software that performs logic related to digital collectibles and/or any other suitable media linked to NFT(s) 350. For example, applications(s) 352 can be any suitable web application (e.g., progressive web application, etc.), web technology, native application (e.g., React native), or other suitable software application. In some implementations, applications 352 can interact with a client applications (e.g., web browser, native application, etc.) to display web data to a user, such as web pages, images, videos, digital collectibles, or any other suitable web data. Application(s) 352 can execute at one or more cloud servers, one or more client systems (e.g., smartphones, laptops, tablets, smart devices, wearable systems, etc.), one or more edge servers, any combination thereof, or at any other suitable computing system. Additional details on application(s) 352 are provided below in relation to application(s) 352 of FIG. 4, digital collectible 500 of FIG. 5, diagram 600 of FIG. 6, process 700 of FIG. 7, process 800 of FIG. 8, and process 900 of FIG. 9.

Collection metric engine 354 can generate collection metric(s) for users using the users' locked NFT(s). For example, for a given user, collection metric engine 354 can select the user's locked NFTs with a matching parameter (e.g., same player identifier, same team identifier, etc.), look up or determine an assigned value for each selected NFT, and aggregate the assigned values to generate the collection metric. In some implementations, a collection metric can be generated for any suitable player identifier or team identifier. Additional details on collection metric engine 354 are provided below in relation to digital collectible 500 of FIG. 5, diagram 600 of FIG. 6, process 700 of FIG. 7, process 800 of FIG. 8, and process 900 of FIG. 9.

In some implementations, blockchain controller 344, smart contract(s) 346, and blockchain(s) 348 can implement any suitable blockchain and/or NFT standard or architecture, such as Flow and Flow Token, Ethereum (e.g., ERC 721, etc.), or any other suitable blockchain and/or NFT standard or architecture.

FIG. 4 is a conceptual diagram illustrating components for locking non-fungible token (NFT) transfer(s) to support NFT collection(s). Diagram 400 includes users 402, blockchain service 404, user token wallet(s) 406, user client(s) 408, smart contracts 346, blockchain(s) 348, and application(s) 352. Application(s) 352 and blockchain service 404 can provide users 402 a digital collectible application service backed by NFTs.

For example, blockchain(s) 348 can be distributed ledger(s) that store the ownership information for a set of NFTs. The set of NFTs can be linked to digital collectibles. A digital collectible can be any suitable unit of data (e.g., data structure) that can be displayed via a display component. For example, a digital collectible can be displayed via a three-dimensional display component, two-dimensional display component, and/or any other suitable display component. Digital collectible 500 of FIG. 5 illustrates a three-dimensional digital collectible, however any other suitable digital collectible can be implemented.

In some implementations, the digital collectibles comprise features, such as affiliated players, teams, statistical information, media files (e.g., images, videos, etc.) or any other suitable information related to a player. Users 402 can acquire NFTs linked to digital collectibles offered by application(s) 352. For example, application(s) 352 can offer a marketplace of digital collectibles/NFTs that supports transfers among users 402, digital packs of digital collectibles/NFTs that the user can claim (e.g., purchase, win from a contest, etc.), and the like.

Blockchain service 404, smart contract(s) 346, and blockchain(s) 348 implement the transfer of NFTs from one token wallet to another token wallet. For example, execution of one or more smart contract(s) can transfer a NFT (and linked digital collectible) from one of user token wallet(s) 406 to another one of user token wallet(s) 406 and record the transfer at blockchain(s) 348. In another example, a token wallet at application(s) 352 can store minted NFTs, and execution of one or more smart contract(s) can transfer a minted NFT (and linked digital collectible) from a token wallet at application(s) 352 to one of user token wallet(s) 406 and record the transfer at blockchain(s) 348.

User client(s) 408 can comprise a web browser, native application, or any other suitable client application that can display web data to users 402. Application(s) 352 can display web content related to the digital collectible(s) to user 402 via user client(s) 408. Users 402 can interact with user client(s) 408 to manage collections of digital collectibles/NFTs, trade NFTs at the marketplace offered by application(s) 352, acquire new digital collectibles/NFTs, and the like.

In some implementations, application(s) 352 permit users 402 to lock one or more NFT(s) owned by each user. For example, a locked NFT is restricted from transfer away from the user for a predefined period of time (e.g., until expiration of the lock timer). Locked NFTs can participate in user interactions that unlocked NFTs do not. For example, diagram 600 of FIG. 6 illustrates leaderboards for a player and a team that correspond to locked NFT(s).

In some implementations, smart contract(s) 346 include a locking smart contract that locks a particular NFT (and the particular digital collectible linked to the particular NFT) to a particular one of users 402. For example, a locking smart contract can: 1) remove the particular NFT from the owner's token wallet; 2) deposit the particular NFT into a locking token wallet; and 3) return the NFT to the owner's token wallet. In this example, the locking token wallet can perform one or more locking actions that lock the NFT to its owner user. For example, a separate one of blockchain(s) 348 can comprise a ledger of locked NFTs (e.g., NFT identifiers). The locking smart contract and/or locking token wallet can write the particular NFT's identifier to the separate one of blockchain(s) 348 to signify that the particular NFT is locked. The separate data structure that stores locked NFT identifiers can be any other suitable data structure.

One or more transaction smart contract(s) 346 can comprise a condition that requires an NFT to be unlocked in order to perform an NFT transfer. In this example, the one or more transaction smart contract(s) 346 can access the separate one of blockchain(s) 348 to perform a lock check that determines whether an NFT attempted to be transferred is locked. When an identifier for the NFT attempting to be transferred is indicated as locked via the separate one of blockchain(s) 348, smart contract(s) 346 do not perform the transfer. For example, an error can be returned to users 402 and/or user client(s) 408 that attempted the transfer indicating that the locked NFT cannot be transferred until the lock expiration time.

In some implementations, smart contract(s) 346 and/or the locking token wallet can alter token data of an NFT that indicates the NFT is locked. For example, a value of a data field of the NFT that indicates its status (e.g., locked or unlocked) can be altered, and the altered data field value can be written to blockchain(s) 348. One or more transaction smart contract(s) 346 can comprise a condition that checks the data field value to determine whether the NFT is locked or unlocked. In this example, when an NFT attempting to be transferred comprises a data field value that indicates the NFT is locked (e.g., as reflected at blockchain(s) 348), smart contract(s) 346 do not perform the attempted transfer. An error can be returned to users 402 and/or user client(s) 408 that attempted the transfer indicating that the locked NFT cannot be transferred until the lock expiration time.

In another example, user token wallet(s) 406 can comprise two storage portions, a portion that stores unlocked NFTs and a portion that stores locked NFTs. In this example, one or more transaction smart contract(s) 346 can comprise a condition that requires an NFT to be in the unlocked portion of user token wallet(s) 406 in order to execute an NFT transaction. An error can be returned to users 402 and/or user client(s) 408 that attempt to transfer an NFT in the locked portion of one of user token wallet(s) 406 indicating that the locked NFT cannot be transferred until the lock expiration time.

In some implementations, application(s) 352 can comprise logic that blocks calls to smart contract(s) 346 when an attempted NFT transaction includes a locked NFT. For example, application(s) 352 can store a data structure that holds locked NFT identifiers, and when a transaction is attempted that includes a locked NFT identifier, application(s) 352 can block call(s) to smart contract(s) 346 that execute NFT transactions. An error can be returned to users 402 and/or user client(s) 408 that attempt the transfer of a locked NFT indicating that the locked NFT cannot be transferred until the lock expiration time.

In some implementations, upon expiration of a lock timer for an NFT (e.g., after the predefined lock time period, such as 6 months, 1 year, 18 months, etc., has expired), the NFT can be unlocked from the user. For example, one or more smart contract(s) 346 can be triggered that remove the token identifier from a separate data structure that stores locked NFT identifiers (e.g., separate one of blockchains 348). In another example, one or more smart contract(s) 346 and or user token wallet(s) 406 can be triggered that move the NFT from portion of a user's token wallet that stores locked NFTs to a portion of the user's token wallet that stores unlocked NFTs. In another example, one or more smart contract(s) 346 can be triggered to alter a value in a data field of the NFT that indicates the NFT's locked status, and this alteration can be recorded at blockchain(s) 348. In another example, application(s) 352 can update a data structure that holds locked NFT identifiers to remove the NFT, and, based on the update, application(s) 352 can permit call(s) to smart contract(s) 346 that execute NFT transactions using the NFT. The unlocked NFT can then be freely transferred among users 402, for example via call(s) to smart contract(s) 346.

Each NFT can be linked to one of a set of digital collectibles, and transfer of these NFTs can transfer ownership of the linked digital collectible. Users 402 can therefore purchase and/or receive NFTs and corresponding digital collectibles from one another or from originating source(s) of the NFTs/digital collectibles. FIG. 5 is a conceptual diagram of a digital collectible affiliated with an NFT. Digital collectible 500 is a three-dimensional digital collectible affiliated with a player. The three-dimensional digital collectible can be a virtual n-sided structure (e.g., 3-sided, 4-sided, 6-sided, etc.). Surface(s) of digital collectible 500 can display digital media file(s), such as a moment affiliated with the player. Digital collectible 500 can be a cube, pyramid, octagon, or other three-dimensional shape.

In some implementations, an instance of a digital collectible 500 can be linked to a minted NFT, and ownership of the digital collectible 500 can be passed via ownership of the minted NFT. For example, the owner of the minted NFT can view the digital collectible via an application and user client (e.g., browser, native application, etc.), include the digital collective in collection(s), or interact with the digital collectible in any other suitable manner.

Digital collectible 500 includes several design components that can be altered or removed in some implementations, and one or more additional design components can be added in some implementations. Digital collectible 500 can comprise media file 528, such as an image or video file. Media file 528 can be displayed on one or more sides of digital collectible 500, such as surface 226. In the illustrated example, media file 528 is displayed at surface 226 under glass 530 (e.g., a transparent or semi-transparent layer), which is rendered such that it overlays at a first distance from surface 226. Indicator 534 can indicate the type of media for media file 528, such as a video file that can be displayed/played at digital collectible 500. In some implementations, digital collectible 500 can be affiliated with a player (e.g., via a player identifier) and a team (e.g., via a team identifier). Name 532 can display the name of the affiliated player. In some implementations, name 532 is displayed at glass 530.

In some implementations, digital collectible 500 can be rotated, such as via an animation of the digital collectible and/or in response to user input. Second surface 522 of digital collectible 500 can display any other suitable information about the affiliated team and/or affiliated player. In the illustrated example, second surface 522 displays data 524, or an image of the affiliated team's logo. Data 524 can comprise any suitable media file, information (e.g., statistics about the affiliated player and/or team, data about media file 528, etc.), or any other suitable information. Digital collectibles linked to NFTs in various implementations can be designed in any other suitable manner (e.g., two-dimensional displays, other three-dimensional displays, etc.), include any other suitable data and/or media files, and/or otherwise comprise any other suitable structure.

Implementations of digital collectibles comprise one or more parameters and parameter values. For example, a first parameter can be a player identifier and a second parameter can be a team identifier. Implementations can generate collection metrics for a given user based on the user's locked NFTs that comprise matching parameters values (e.g., locked NFTs affiliated with the same player, locked NFTs affiliated with the same team, etc.). FIG. 6 is a conceptual diagram of leaderboards that correspond to ranked collection metrics. Diagram 600 includes player leaderboard 602 and team leaderboard 604. Player leaderboard displays user ranking 606 and team leader board displays user ranking 608. Player leaderboard 602 is generated for a particular player and team leaderboard 606 is generated for a particular team.

In some implementations, a score is calculated for each user of user ranking 606 based on each user's locked NFT(s) that are affiliated with the particular player. For example, each locked NFT can comprise an assigned value, and the score for a given user is the aggregate of the assigned values of the user's locked NFTs affiliated with the particular player. These users' scores are ranked and displayed as user ranking 606.

In some implementations, a score is calculated for each user of user ranking 608 based on each user's locked NFT(s) that are affiliated with the players that are members of the particular team. For example, each locked NFT can comprise an assigned value, and the score for a given user is the aggregate of the assigned values of the user's locked NFTs affiliated with the players that are members of the particular team. These users' scores are ranked and displayed as user ranking 608.

Leaderboards 602 and 604 and user rankings 606 and 608 can encourage users to build collection(s) of locked digital collectibles/NFTs. For example, because the leaderboards are published to the community of users, they can serve as a mechanism for users to publicly demonstrate their fandom for a given player and/or team. In some implementations, certain limited-edition digital collectibles or competition(s) to win certain limited-edition digital collectible(s) can be exclusively offered to users that rank at a certain level (e.g., top 50, top 100, top 200, etc.) on user rankings 606 and/or 608.

In some implementations, the assigned value for a locked digital collectible/NFT can be determined based on a marketplace value for the digital collectible/NFT, purchase value of the digital collectible/NFT, and/or the value of the digital collectible/NFT when the NFT was locked to the user. For example, digital collectibles and the NFTs to which they are linked can be traded among users at a marketplace. A transaction that changes ownership of a digital collectible/NFT can comprise a corresponding transaction value (e.g., sale value).

Some digital collectibles can be part of a set of digital collectibles that each include the same matching features (e.g., affiliated player, digital media file, etc.). In some examples, the number of these digital collectibles with matching features can be limited. In the marketplace, digital collectibles that comprise the same matching features can comprise the same (or similar) transaction value(s).

In some implementations, an assigned value for a locked digital collectible/NFT can be the purchase price of the digital collectible/NFT or the average marketplace transaction value for the set of digital collectibles that comprise the same features over a period of time (e.g., last week, last 30 days, last 60 days, etc.). In this example, the assigned value of a given locked digital collectible/NFT can fluctuate based on the marketplace transaction value(s) for the set of NFTs with matching features at the marketplace. In some implementations, the assigned value for a locked digital collectible/NFT can be the greater of: the purchase price of the digital collectible/NFT; the average marketplace transaction value for set of digital collectibles that comprise the same features; or the assigned value for the locked digital collectible/NFT at the time it was locked. The assigned value for the locked digital collectible/NFT at the time it was locked can correspond to the purchase price of the digital collectible/NFT or the average marketplace transaction value for set of digital collectibles that comprise the same features at the time the NFT was locked to the user. In this example, the assigned value of a locked NFT can raise above its original assigned value at the time it was locked, but not fall below this original value.

Those skilled in the art will appreciate that the components illustrated in FIGS. 1-6 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 7 is a flow diagram illustrating a process used in some implementations for locking NFT transfer(s) to support NFT collection(s). In some implementations, process 700 can be triggered when a NFT linked to a digital collectible is transferred to a user's token wallet. Process 700 can be performed by web application(s), user client(s) (e.g., web browser, native application, etc.), blockchain service(s), or any other suitable software components. Process 700 can be performed at a cloud system, edge system, client system, or any combination thereof.

At block 702, process 700 can transfer ownership of a NFT to a user token wallet. For example, one or more smart contract(s) can execute a transfer of a NFT linked to a digital collectible from an original token wallet (e.g., user token wallet, originating source token wallet) to the user token wallet. The transfer of the NFT to the user token wallet represents a change of ownership with respect to the digital collectible linked to the NFT.

At block 704, process 700 can determine whether a lock command is received from a user. For example, NFTs (and their linked digital collectibles) can be transferred among users, such as via a digital collectible marketplace. In some implementations, a user can lock an NFT to the user for a predefined period of time. Such a locked NFT disables ownership transfer of the NFT and its linked digital collectible from the user for the period of time. The user can provide a lock command via a user client (e.g., browser, native application, etc.). When a lock command is received from the user, process 700 can progress to block 708. When the lock command is not received from the user, process 700 can progress to block 706, where the NFT can be maintained as a transferrable NFT.

At block 708, process 700 can lock the NFT to the user for a predefined period of time. For example, the NFT can be locked to the user over a lock time period (e.g., 6 months, 1 year, 18 months, etc.). Locking the NFT and the linked digital collectible to the user can include one or more of: adding the NFT identifier to a separate data structure that maintains locked NFTs; altering the token data of the NFT to indicate the locked status; moving the NFT to a portion of the user's token wallet that stores locked NFTs; and/or any other suitable locking action. Process 800 of FIG. 8 further describes techniques to lock a NFT to a user.

At block 710, process 700 can generate collection metric(s) using the locked NFT. For example, the digital collectibles associated with NFTs can comprise features, such as affiliated players, affiliated teams, digital media file(s), etc. A collection of digital collectibles can include a set of collectibles that comprise: the same player identifier; or the same team identifier. The collection metric for a given user with respect to a specific player identifier can be the aggregate of the assigned values for NFTs/digital collectibles that are: affiliated with the specific player identifier; and locked to the user. The collection metric for a given user with respect to a specific team identifier can be the aggregate of the assigned values for NFTs/digital collectibles that are: affiliated with the specific team identifier; and locked to the user. Process 900 of FIG. 9 further describes techniques to generate collection metrics by determining assigned value(s) for locked NFT(s).

At block 712, process 700 can display the collection metric(s) for a plurality of users. For example, a user can comprise a collection metric for a specific player based on the aggregate of assigned values for digital collectibles/NFTs affiliated with the specific player that are locked to the user. A user can also comprise a collection metric for a specific team based on the aggregate of assigned values for digital collectibles/NFTs affiliated with the specific team that are locked to the user. For a specific player, the user's collection metric can be ranked against the player specific collection metrics for a community of users, and this ranking can be published to the community of users at a player specific leaderboard. For a specific team, the user's collection metric can be ranked against the team specific collection metrics for a community of users, and this ranking can be published to the community of users at a team specific leaderboard.

At block 714, process 700 can determine whether the lock time for the NFT has expired. For example, an NFT/digital collectible can be locked to a user for a limited duration of time. Once the lock time for the NFT expires, the NFT can be unlocked from the user. When the lock time has expired, process 700 can progress to block 718. When the lock time has not expired, process 700 can loop back to block 714 until the lock time has expired.

At block 718, process 700 can unlock the NFT from the user. Example techniques to unlock the NFT/digital collectible from the user include one or more of: removing the NFT identifier from a separate data structure that stores locked NFT identifiers or appending a transaction to a separate blockchain that indicates the NFT identifier is no longer locked; moving the NFT from a portion of the user's token wallet that stores locked NFTs to a portion of the user's token wallet that stores unlocked NFTs; altering a value in a data field of the NFT that indicates the NFT's locked status; any combination thereof; or any other suitable unlocking action. After the NFT is unlocked form the user, process 700 can progress to block 706, where the unlocked NFT is maintained as a transferrable NFT.

In some implementations, unlocking the NFT from the user comprises a manual user action. For example, once the lock time expires, the user is permitted to unlock the NFT, however the unlock involves manual user action (e.g., user input via a web application/user client) that explicitly unlocks the NFT from the user. In some implementations, after the lock time expires the NFT remains locked to the user until the manual user unlocking action is performed.

FIG. 8 is a flow diagram illustrating a process used in some implementations for locking an NFT to a user via a locking smart contract. In some implementations, process 800 can be triggered when a user initiates a lock of an owned NFT. Process 800 can be performed by web application(s), user client(s) (e.g., web browser, native application, etc.), blockchain service(s), or any other suitable software components. Process 800 can be performed at a cloud system, edge system, client system, or any combination thereof.

At block 802, process 800 can move the NFT to the locking smart contract's functional scope. For example, one or more smart contracts (or any other software component) can move the NFT to the locking smart contract's functional scope such that the locking smart contract is provided authority over the NFT. Any other suitable technique to delegate authority over the NFT to the locking smart contract can be implemented.

At block 804, process 800 can perform user locking. For example, the user locking can be performed based on the authority the locking smart contract has over the NFT. A lock wallet and/or one or more locking smart contracts can perform one or more user locking actions that lock the NFT to the owner user. For example, a separate blockchain can be a ledger of locked NFTs (e.g., NFT identifiers). The locking smart contract and/or lock wallet can write the particular NFT's identifier to the separate blockchain to signify that the particular NFT is locked. The separate data structure that stores locked NFT identifiers can be any other suitable data structure.

One or more transaction smart contract(s) can comprise a condition that requires an NFT to be unlocked in order to perform an NFT transfer. In this example, the one or more transaction smart contract(s) can access the separate blockchain to perform a lock check that determines whether an NFT attempted to be transferred is locked. When an identifier for the NFT attempting to be transferred is indicated as locked via the separate blockchain, the smart contract(s) do not perform the transfer.

In some implementations, locking smart contract(s) and/or the lock wallet can alter token data of the NFT to lock it to the user. For example, the value of a data field of the NFT that indicates its status (e.g., locked or unlocked) can be altered, and the altered data field value can be written to a blockchain that manages the NFT. One or more transaction smart contracts can comprise a condition that checks the data field value to determine whether the NFT is locked or unlocked. In this example, when an NFT attempting to be transferred comprises a data field value that indicates the NFT is locked, transaction smart contract(s) do not perform the transfer.

In some implementations, the user's token wallet can comprise two storage portions, a portion that stores unlocked NFTs and a portion that stores locked NFTs. The locking smart contract(s) and/or lock wallet can move the locked NFT into the portion of the user's token wallet designated for locked NFTs. In this example, one or more transaction smart contract(s) can comprise a condition that requires an NFT to be in the unlocked portion of user token wallet in order to execute an NFT transaction that changes ownership of the NFT.

At block 806, process 800 can resume the functional scope(s) with respect to the NFT. For example, the NFT may no longer be within the locking smart contract's functional scope (as the locking has already been performed). In some implementations, one or more smart contracts (or any other suitable software component) can remove the NFT from the locking smart contract's functional scope, or the NFT may be removed from the locking smart contract's functional scope automatically after locking is performed.

FIG. 9 is a flow diagram illustrating a process used in some implementations for generating collection metric(s), ranking the metric(s), and displaying the ranking of metric(s). In some implementations, process 900 can be triggered when a user locks one or more NFT(s) and/or views leaderboard(s) that correspond to locked user NFT(s). Process 900 can be performed by web application(s), user client(s) (e.g., web browser, native application, etc.), blockchain service(s), or any other suitable software components. Process 900 can be performed at a cloud system, edge system, client system, or any combination thereof.

At block 902, process 900 can select a given user's NFT(s) with a matching parameter. For example, the digital collectibles associated with NFTs can comprise features, such as affiliated players, affiliated teams, digital media file(s), etc. A collection of digital collectibles can include a set of collectibles that comprise: the same player identifier; or the same team identifier. In some implementations, the matching parameter for the selected NFTs can be a same player identifier or a same team identifier.

At block 904, process 900 can determine assigned values for each selected NFT. In some implementations, an assigned value for a locked digital collectible/NFT can be the average marketplace transaction value for set of digital collectibles that comprise the same features over a period of time (e.g., last week, last 30 days, last 60 days, etc.). In some implementations, the assigned value for a locked digital collectible/NFT can be the greater of either: the average marketplace transaction value for the set of digital collectibles that comprise the same features; or the assigned value for the locked digital collectible/NFT at the time it was locked. The assigned value for the locked digital collectible/NFT at the time it was locked can correspond to the average marketplace transaction value for set of digital collectibles that comprise the same features at the time the NFT was locked to the user. In this example, the assigned value of a locked NFT can raise above its original assigned value at the time it was locked, but not fall below this original value.

At block 906, process 900 can generate collection metric(s) using the assigned values. The collection metric for a given user with respect to a specific player identifier can be the aggregate of the assigned values for NFTs/digital collectibles that are: affiliated with the specific player identifier; and locked to the user. The collection metric for a given user with respect to a specific team identifier can be the aggregate of the assigned values for NFTs/digital collectibles that are: affiliated with the specific team identifier; and locked to the user.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for locking non-fungible token (NFT) transfer(s) to support NFT collection(s), the method comprising:
transferring ownership of an NFT to a user affiliated with a token wallet identifier, wherein,
the NFT is linked to a digital collectible from a set of digital collectibles,
the ownership transfer is performed by one or more smart contracts that append the ownership transfer to a blockchain ledger, and
after the ownership transfer, the NFT is configured for transfer from the user to other users via execution of the one or more smart contracts;
receiving, from the user, a lock command for the NFT;
locking, in response to the lock command, the NFT to the user such that transfer of the NFT from the user is disabled for a predefined period of time;
generating a collection metric for the user using the locked NFT, wherein the collection metric is generated by retrieving values assigned to one or more NFTs locked to the user and aggregating the one or more assigned values; and
displaying the collection metric in comparison to collection metrics generated for a plurality of users.

2. The method of claim 1, wherein:
after the ownership transfer, the NFT is transferrable from the user via execution of the one or more smart contracts, and
after the locking and for the period of time, execution of the one or more smart contracts for transfer of the NFT is prevented, making the NFT non-transferrable.

3. The method of claim 1, wherein locking, in response to the lock command, the NFT to the user further comprises:
executing a locking smart contract that withdraws the NFT from the user, deposits the NFT to a lock wallet, and returns the NFT to the user, wherein one or more locking actions are performed while the NFT is deposited at the lock wallet.

4. The method of claim 3, wherein:
the performed one or more locking actions comprise writing an identifier for the NFT to a database that maintains locked NFTs, and
the one or more smart contracts are prevented from transferring ownership of the NFT from the user while the database indicates the identifier for the NFT is locked.

5. The method of claim 4, wherein the database comprises a separate blockchain ledger.

6. The method of claim 1, wherein locking, in response to the lock command, the NFT to the user further comprises:
altering token data of the NFT, wherein the altered token data identifies the NFT as locked, and the altered token data is written to the blockchain ledger.

7. The method of claim 6, wherein the altered token data prevents the one or more smart contracts from transferring ownership of the NFT from the user.

8. The method of claim 1, wherein locking, in response to the lock command, the NFT to the user further comprises:
transferring the NFT to a locked portion of a user token wallet identified by the token wallet identifier, wherein the one or more smart contracts are prevented from transferring NFTs from the locked portion of the user token wallet.

9. The method of claim 1, further comprising:
unlocking, after the predefined period of time, the NFT from the user, wherein the NFT, after the unlocking, is configured for transfer from the user to other users via execution of the one or more smart contracts.

10. The method of claim 1, wherein the NFT comprises a collection parameter with a collection parameters value, and the one or more assigned values aggregated to generate the collection metric are values assigned to one or more NFTs that comprise a matching collection parameter value.

11. The method of claim 10, wherein:
the collection parameter comprises a team and the collection parameter value comprises a team identifier, or
the collection parameter comprises a player and the collection parameter value comprises a player identifier.

12. The method of claim 1, further comprising:
ranking the collection metric in comparison to the collection metrics generated for the plurality of users, wherein the display the collection metric comprises displaying the ranking.

13. The method of claim 1, wherein:
an assigned value for the NFT locked to the user corresponds to the value of the NFT at a time the NFT was locked to the user.

14. A computer-readable storage medium storing instructions that, when executed by a computing system, cause the computing system to perform a process for locking non-fungible token (NFT) transfer(s) to support NFT collection(s), the process comprising:
transferring ownership of an NFT to a user affiliated with a token wallet identifier, wherein,
the NFT is linked to a digital collectible from a set of digital collectibles,
the ownership transfer is performed by one or more smart contracts that append the ownership transfer to a blockchain ledger, and
after the ownership transfer, the NFT is configured for transfer from the user to other users via execution of the one or more smart contracts;
receiving, from the user, a lock command for the NFT;
locking, in response to the lock command, the NFT to the user such that transfer of the NFT from the user is disabled for a predefined period of time;
generating a collection metric for the user using the locked NFT, wherein the collection metric is generated by retrieving values assigned to one or more NFTs locked to the user and aggregating the one or more assigned values; and
displaying the collection metric in comparison to collection metrics generated for a plurality of users.

15. The computer-readable storage medium of claim 14, wherein:
after the ownership transfer, the NFT is transferrable from the user via execution of the one or more smart contracts, and
after the locking and for the period of time, execution of the one or more smart contracts for transfer of the NFT is prevented, making the NFT non-transferrable.

16. The computer-readable storage medium of claim 14, wherein locking, in response to the lock command, the NFT to the user further comprises:
executing a locking smart contract that withdraws the NFT from the user, deposits the NFT to a lock wallet, and returns the NFT to the user, wherein one or more locking actions are performed while the NFT is deposited at the lock wallet.

17. The computer-readable storage medium of claim 16, wherein:
the performed one or more locking actions comprise writing an identifier for the NFT to a database that maintains locked NFTs, and
the one or more smart contracts are prevented from transferring ownership of the NFT from the user while the database indicates the identifier for the NFT is locked.

18. The computer-readable storage medium of claim 17, wherein the database comprises a separate blockchain ledger.

19. The computer-readable storage medium of claim 14, wherein locking, in response to the lock command, the NFT to the user further comprises:
altering token data of the NFT, wherein the altered token data identifies the NFT as locked, and the altered token data is written to the blockchain ledger.

20. A computing system for locking non-fungible token (NFT) transfer(s) to support NFT collection(s), the computing system comprising:
one or more processors; and
one or more memories storing instructions that, when executed by the one or more processors, cause the computing system to perform a process comprising:
transferring ownership of an NFT to a user affiliated with a token wallet identifier, wherein,
the NFT is linked to a digital collectible from a set of digital collectibles,
the ownership transfer is performed by one or more smart contracts that append the ownership transfer to a blockchain ledger, and
after the ownership transfer, the NFT is configured for transfer from the user to other users via execution of the one or more smart contracts;
receiving, from the user, a lock command for the NFT;
locking, in response to the lock command, the NFT to the user such that transfer of the NFT from the user is disabled for a predefined period of time;
generating a collection metric for the user using the locked NFT, wherein the collection metric is generated by retrieving values assigned to one or more NFTs locked to the user and aggregating the one or more assigned values; and
displaying the collection metric in comparison to collection metrics generated for a plurality of users.
